(19) United States
(12) Patent Application Publication
(10) Pub. No.: US 2025/0139542 A1
(43) Pub. Date: May 1, 2025

(54) SYSTEM AND METHOD FOR ADJUSTING AGENTS STAFFING LEVELS OF A SUCCESSIVE WORK-SHIFT OF A PREASSIGNED ONGOING WORK-SHIFT, DURING THE PREASSIGNED ONGOING WORK-SHIFT, IN A CONTACT CENTER

(71) Applicant: NICE LTD., Ra'anana (IL)

(72) Inventors: Salil DHAWAN, Pune (IN); Rahul VYAS, Jodhpur (IL); Oren GERSTNER, Plano, TX (US); Darshan AMBHAIKAR, Pune (IN)

(21) Appl. No.: 18/383,488

(22) Filed: Oct. 25, 2023

(51) Int. Cl. G06Q 10/0631

(52) U.S. Cl. CPC G06Q 10/063116; G06Q 10/063112

(57) ABSTRACT

A computer-implemented method for adjusting agents staffing levels of a successive work-shift of a preassigned ongoing work-shift, during the preassigned ongoing work-shift, in a contact center. The computer-implemented method includes: (i) during the preassigned ongoing work-shift, determining a number of agents to handle inbound-interactions that require one or more skills for the successive work-shift; (ii) comparing the number of agents to handle inbound-interactions that require one or more skills to a threshold; (iii) when the number of agents to handle inbound-interactions that require one or more skills is above the threshold, calculating a number of extra-agents; and (iv) operating a shift-extension module to: (a) select the calculated number of extra-agents from agents having the one or more skills which are assigned to the preassigned ongoing work-shift; and (b) update corresponding schedules of the selected number of extra-agents, in a database of a Workforce Management (WFM) system.

### TECHNICAL FIELD

The present disclosure relates to the field of data analysis for adjusting agents staffing levels of a preassigned successive work-shift, during the preassigned ongoing work-shift, in a contact center

### BACKGROUND

Effective scheduling of work shifts may be crucial for any contact center as it can have a significant impact on operational costs. When scheduling too many agents for a work-shift with a low call volume, it can result in wasted resources in the form of overstaffing. On the other hand, when there is an unexpected surge in call volume and the contact center is understaffed, the consequences may be even more costly. When the number of incoming calls to a call center suddenly exceeds its forecasted or regular volume, it is referred to as a call volume spike or high call volume. This sudden surge in calls can occur for a brief period or extend over several hours, days, or even weeks and can lead to a shortage of staff during critical times.

In contact centers, managing an unexpected surge in call volume is crucial for a contact center to ensure that agents do not experience burnout, maintain their morale, optimize costs, and continue to provide a consistently positive customer experience despite the rise in the call volume. This understaffing situation also results into increased wait time, poor customer experience, increased agent turnover, lost revenue, and reduced efficiency.

Not all businesses have the resources to hire temporary staff in an understaffing situation. However, implementing a strategy where agents can extend their live work-shifts can be a mutually beneficial solution for both the contact center and agents during such situations. To efficiently manage temporary call surges, there is a need for a technical solution that may optimize the utilization of existing agents by extending their ongoing work-shift. The needed technical solution should extend the live work-shifts of agents or provide advanced information to adjust staffing levels, thus preventing both understaffing and overstaffing scenarios.

Moreover, in times of crisis, when the contact center is understaffed, not all businesses have the resources to hire temporary staff to overcome the high-volume calls and provide the desired level of service. Therefore, to efficiently manage temporary calls surge, there is a need for a technical solution to optimize utilization of agents by extending the ongoing work-shift of the agents in the contact center or providing advanced information to adjust staffing levels.

Accordingly, there is a need for system and method for adjusting agents staffing levels of a preassigned successive work-shift, during the preassigned ongoing work-shift, in a contact center.

### SUMMARY

There is thus provided, in accordance with some embodiments of the present disclosure, a computer-implemented method for adjusting agents staffing levels of a successive work-shift of a preassigned ongoing work-shift, during the preassigned ongoing work-shift, in a contact center.

Furthermore, in accordance with some embodiments of the present disclosure, the computer-implemented method may include: (i) during the preassigned ongoing work-shift, determining a number of agents to handle inbound-interactions that require one or more skills for the successive work-shift; (ii) comparing the number of agents to handle inbound-interactions that require one or more skills to a threshold; (iii) when the number of agents to handle inbound-interactions that require one or more skills is above the threshold, calculating a number of extra-agents; and (iv) operating a shift-extension module to: (a) select the calculated number of extra-agents from agents having the one or more skills which are assigned to the preassigned ongoing work-shift; and (b) update corresponding schedules of the selected number of extra-agents, in a database of a Workforce Management (WFM) system.

Furthermore, in accordance with some embodiments of the present disclosure, the determining of the number of agents to handle inbound-interactions that require one or more skills may be operated by a forecasting module.

Furthermore, in accordance with some embodiments of the present disclosure, the threshold may be a sum of a number of agents having the one or more skills which are assigned to the successive work-shift and a preconfigured buffer.

Furthermore, in accordance with some embodiments of the present disclosure, the calculating of the number of extra-agents comprising reducing from the number of agents to handle inbound-interactions that require one or more skills a number of agents that are currently assigned to the successive work-shift.

Furthermore, in accordance with some embodiments of the present disclosure, the shift-extension module may include (i) calculating Agent Shift Extension Score (ASES) for each agent having one or more skills which are assigned to the preassigned ongoing work-shift; (ii) sorting the agents having one or more skills which are assigned to the preassigned work-shift based on the calculated ASES in a descending order and storing the agents having one or more skills which are assigned to the preassigned work-shift and calculated ASES in a shift-tracking data-store: (iii) retrieving from the shift-tracking data-store one or more agents having a calculated ASES that is above a preconfigured ASES-threshold; (iv) when the retrieved one or more agents having a calculated ASES that is above a preconfigured ASES-threshold is not below the determined number of agents to handle inbound-interactions that require one or more skills, selecting the number of extra-agents from the retrieved one or more agents having a calculated ASES; and when the retrieved one or more agents having a calculated ASES that is above a preconfigured ASES-threshold is below the determined number of agents to handle inbound-interactions that require one or more skills, updating the preconfigured ASES-threshold by a preconfigured percentage and repeating operations (iii) thru (v) with the updated preconfigured ASES-threshold as the preconfigured ASES-threshold.

Furthermore, in accordance with some embodiments of the present disclosure, the calculating of ASES for each agent in the agents having one or more skills which are assigned to the preassigned work-shift is according to formula I:
(I)

$$ASES Agent i = {\sum }_{Criterion k = 0}^{m} ( score of criterion k * Weight of criterion k )$$

whereby:
m is the number of criteria, and the ASES score for Agent i is computed by summing up the products of the score of each criterion k and the preconfigured weight of that criterion k.

Furthermore, in accordance with some embodiments of the present disclosure, the selecting of the number of extra-agents from the retrieved one or more agents having a calculated ASES may include selecting the number of extra-agents from the retrieved one or more agents having highest calculated ASES.

Furthermore, in accordance with some embodiments of the present disclosure, after the selecting of the number of extra-agents from the retrieved one or more agents having a calculated ASES the computer-implemented method may further include marking agents from the retrieved one or more agents that were not selected as backup.

Furthermore, in accordance with some embodiments of the present disclosure, the calculating of ASES may be operated after a selection of agents from a list of agents marked as volunteered-for-extension and reducing the selected number of agents from the list of agents marked as volunteered-for-extension from the number of extra-agents.

Furthermore, in accordance with some embodiments of the present disclosure, the operating of the shift-extension module may further include checking a duration of extension of time for each agent against maximum-allowable duration and rotating each agent that the duration of time has exceeded the maximum-allowable duration to balance the workload and scheduling.

Furthermore, in accordance with some embodiments of the present disclosure, when the determined number of agents to handle inbound-interactions that require one or more skills for the successive work-shift number is higher than the number of agents that were assigned to the successive work-shift and below the threshold, the computer-implemented method may further include sending a notification as to an overstaffing scenario to a computerized device to be displayed thereon.

Furthermore, in accordance with some embodiments of the present disclosure, when the determined number of agents to handle inbound-interactions that require one or more skills for the successive work-shift number is lower than the number of agents that were assigned to the successive work-shift the computer-implemented method may further include calculating Agent Shift Extension Score (ASES) for each agent having one or more skills which are assigned to the preassigned ongoing work-shift and sending Voluntary Time Off (VTO) and Paid Time Off (PTO) suggestions to a computerized-device of an excess-number of agents having lowest calculated ASES.

### BRIEF DESCRIPTION OF THE DRAWINGS

FIG. 1 schematically illustrates a high-level diagram of a computer-implemented method for adjusting agents staffing levels of a successive work-shift of a preassigned ongoing work-shift, during the preassigned ongoing work-shift, in a contact center, in accordance with some embodiments of the present disclosure;

FIG. 2 is a high-level workflow of a computer-implemented method for adjusting agents staffing levels of a successive work-shift of a preassigned ongoing work-shift, during the preassigned ongoing work-shift, in a contact center, in accordance with some embodiments of the present disclosure;

FIG. 3 schematically illustrates a high-level diagram of a system for adjusting agents staffing levels of a successive work-shift of a preassigned ongoing work-shift, during the preassigned ongoing work-shift, in a contact center, in accordance with some embodiments of the present disclosure;

FIGS. 4A-4B are tables of assigned weights to each criterion and weights assigned to key parameters, in accordance with some embodiments of the present disclosure;

FIG. 5 is a table of agent work-shift extension prioritization, in accordance with some embodiments of the present disclosure;

FIG. 6 is an example of work-shift extension, in accordance with some embodiments of the present disclosure;

FIGS. 7A-7C is an example of calculation of weighted scores for agents, in accordance with some embodiments of the present disclosure;

FIG. 8 is an example of agents selection for further work-shift extension, in accordance with some embodiments of the present disclosure; and

FIG. 9 is an example of User Interface (UI) for work-shift extension, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example. “processing,” “computing,” “calculating,” “determining.” “establishing”, “analyzing”. “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

During sale times in websites, such as Amazon® or Flip Cart® there is a high surge of calls volume which requires a higher number of agents for specific time frame or duration. Also, during a festive season when people are traveling, and using transportation means, they may enquire as to related details and may use a digital channel medium for it. Hence, the digital channel contact center may need a higher number of agents for extended period.

The hiring of additional agents through an external entity can be cost intensive and may not be a practical solution. At the same time there may be highly motivated and engaged agents who may be willing to contribute during the surge in calls volume by extended their preassigned ongoing work-shift such that they may be assigned to a successive work-shift.

Therefore, there is a need for system and method for adjusting agents staffing levels of a successive work-shift of a preassigned ongoing work-shift, during the preassigned ongoing work-shift, in a contact center.

The term “preassigned ongoing work-shift”, as used herein, refers to a work-shift that includes working agents which were scheduled to the work-shift via a Workforce Management (WFM) system and attend the work-shift, e.g., logged on to a work terminal of the contact center.

The term “successive work-shift of a preassigned ongoing work-shift”, as used herein, refers to a preassigned work-shift that includes different agents than the preassigned ongoing work-shift, which are not logged on to a work terminal of the contact center yet.

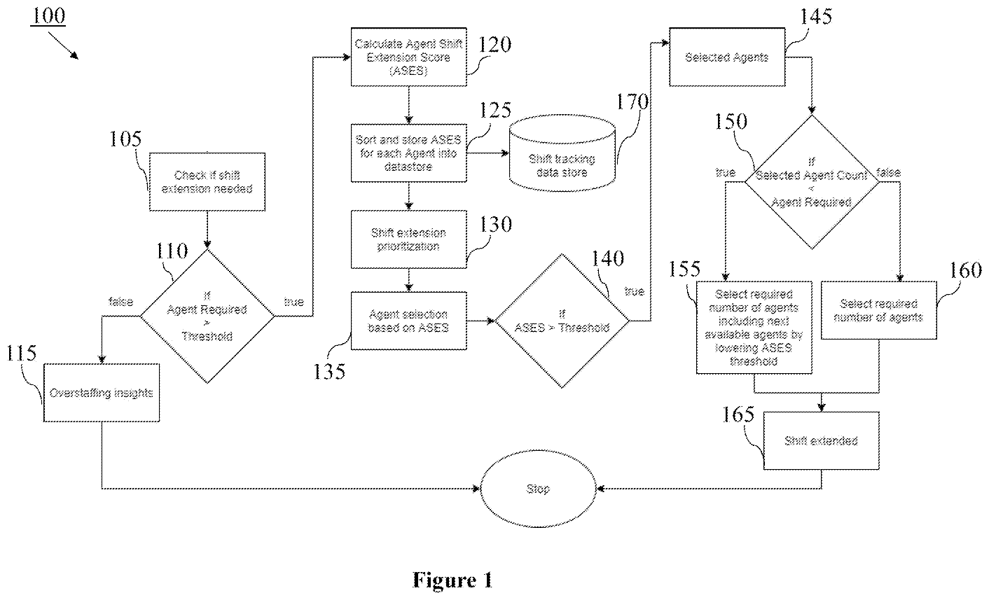

FIG. 1 schematically illustrates a high-level diagram of a computer-implemented method 100 for adjusting agents staffing levels of a successive work-shift of a preassigned ongoing work-shift, during the preassigned ongoing work-shift, in a contact center, in accordance with some embodiments of the present disclosure.

According to some embodiments of the present disclosure, a system, such as system 300, may implement a computer-implemented method 100 for adjusting agents staffing levels of a successive work-shift of a preassigned ongoing work-shift, during the preassigned ongoing work-shift, in a contact center.

According to some embodiments of the present disclosure, during a preassigned ongoing work-shift, determining a number of agents to handle inbound-interactions that require one or more skills for the successive work-shift, e.g., during a preassigned ongoing work-shift in a contact center, check if shift extension is needed 105. The check is for the successive work-shift of the preassigned ongoing work-shift base on an updated forecast for required agents having one or more skills. The forecast may be provided by a forecasting module.

According to some embodiments of the present disclosure, a forecasting module may continuously monitor inbound-interactions volume for specific parameters such as Average Handling Time (AHT), queue size, number of agents available against anticipated trend to anticipate a sudden spike. For example, the Erlang C formula may be leveraged to anticipate a sudden spike by calculating the number of agents that are required in a contact center, given the number of calls and the service level to be achieved.

$$\begin{matrix}pi > oi = \frac{\frac{{A}^{N}}{N !} ( \frac{N}{N - A} )}{{\sum }_{x = 0}^{N - 1} \frac{{A}^{′}}{X !} + \frac{{A}^{N}}{N !} ( \frac{N}{N - A} )} \\ Where : \\ A = total traffic ( in erlang c ) \\ N = number of resources \\ Pi > Oi = probability of delay \\ P = probability of loss - Poisson formula\end{matrix} \qquad Erlang C Formula$$

According to some embodiments of the present disclosure, if agents required is not more than a threshold, overstaffing insights 115 may be sent, i.e., when the determined number of agents to handle inbound-interactions that require one or more skills for the successive work-shift number is higher than the number of agents that were assigned to the successive work-shift and below the threshold, the a notification as to an overstaffing scenario may be sent to a computerized-device to be displayed thereon.

According to some embodiments of the present disclosure, optionally, when the work-shift extension is required, a list of agents that have volunteered for shift extension may be retrieved. The list of agents may include agents which are assigned to the preassigned ongoing work-shift.

According to some embodiments of the present disclosure, comparing the number of agents to handle inbound-interactions that require one or more skills to a threshold, e.g., if agents required are more than a threshold 110. The threshold may be a minimum number of agents required after which work-shift extension may be considered. If the total number of agents required is less than the threshold, the operation of the agents shift extension module may not be required. The threshold value may be set by the administrator of a contact center and the threshold value may consider total number of agents required to handle the call against duration of the spike in inbound-interactions.

According to some embodiments of the present disclosure, the threshold refers to the least number of agents needed to trigger the consideration of extending work-shifts. This minimum number is determined by the administrator, who considers the total number of agents in the contact center. For example, the administrator may decide that work-shift extensions are only to be considered when more than 20 agents are required. If the need is for only 5-10 agents, then the work-shifts may not be extended.

According to some embodiments of the present disclosure, the threshold shouldn't be set too low because the contact center might end up frequently extending work-shifts leading to potential costs and agent fatigue on the other hand if the threshold is set too high, then service levels may be compromised. The process of determining threshold may be based on various factors and it may change for every contact center. One such method may be to define the value based on percentage of agents active in an ongoing work-shift, e.g., live work-shift. If for example, a live shift has 100 agents and percentage defined by administrator is 25 percent, then work-shift extension may trigger if requirement of agent for work-shift extension exceeds 25 percent.

According to some embodiments of the present disclosure, the threshold may be a sum of a number of agents having the one or more skills which are assigned to the successive work-shift and a preconfigured buffer.

According to some embodiments of the present disclosure, the threshold may be calculated by checking average additional call volume during the spikes and then determine an average number of calls that agents can handle beyond their regular capacity. The threshold can be set as average additional call volume divided by the number of calls an extra hour of agent work can handle.

According to some embodiments of the present disclosure, in another example, the threshold may be calculated by taking into consideration Service Level Agreement (SLA) and when the spike causes SLA adherence to drop below an acceptable level then consider extending shifts. For example, if SLA requires 90% of calls to be answered within 40 seconds and the spike causes this to drop to 70%, then determining the total number of agents required to handle the extra calls to bring back the SLA to 90% and set that as a threshold.

According to some embodiments of the present disclosure, when the number of agents to handle inbound-interactions that require one or more skills is above the threshold, a number of extra-agents may be calculated. Optionally, if the number of volunteered agents is insufficient to meet the required number of agents, a notification may be sent to agents with the required one or more skills which are logged on a work terminal in the preassigned ongoing work-shift, to offer the shift extension.

According to some embodiments of the present disclosure, the calculating of the number of extra-agents may include reducing from the number of agents to handle inbound-interactions that require one or more skills a number of agents that are currently assigned to the successive work-shift. The following parameters may be considered for agents shift extension: total number of available agents, e.g., agents which are logged on to work terminal in an ongoing work-shift, agents which have been volunteered for work-shift extension and agents preferred channels, forecasting details for the successive work-shift of the ongoing work-shift, such as number of number of agents needed to handle the incoming call volume and interactions, one or more skills required to handle the forecasted additional call volume and interactions and shift timing for agents, e.g., work-shift start and end time.

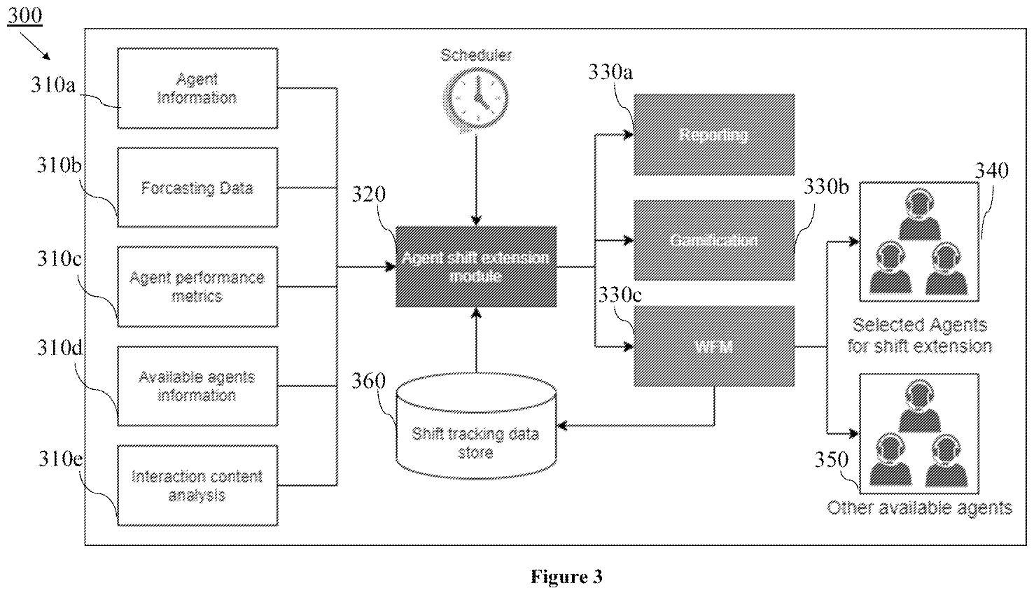

According to some embodiments of the present disclosure, a shift-extension module, such as agent shift extension module 320 in FIG. 3 may be operated to select the calculated number of extra-agents from agents having one or more skills which are assigned to the preassigned ongoing work-shift and then update corresponding schedules of the selected number of extra-agents in a database of a Workforce Management (WFM) system.

According to some embodiments of the present disclosure, the operating of the agent shift-extension module may include calculate Agent Shift Extension Score (ASES) 120 by calculating ASES for each agent having one or more skills which are assigned to the preassigned ongoing work-shift and then sort and store the ASES for each agent into a datastore 125. The data-store a data-store such as shift tracking data store 170, and such as shift tracking data store 360 in FIG. 3.

According to some embodiments of the present disclosure, shift extension prioritization 130 may be operated by checking the ASES score of agents and prioritization of agents with highest ASES for selection for shift extension.

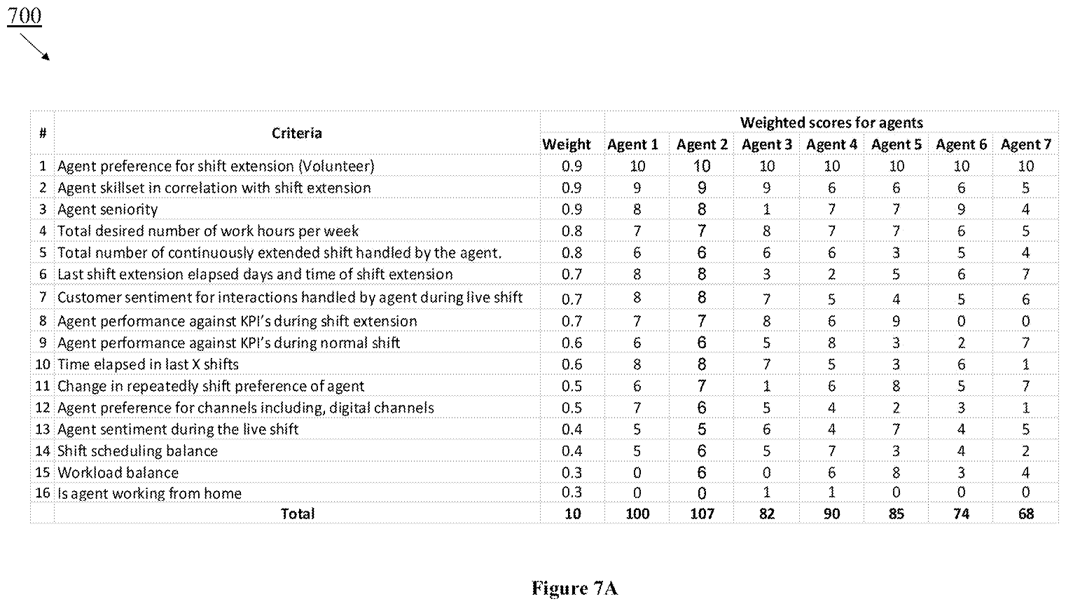

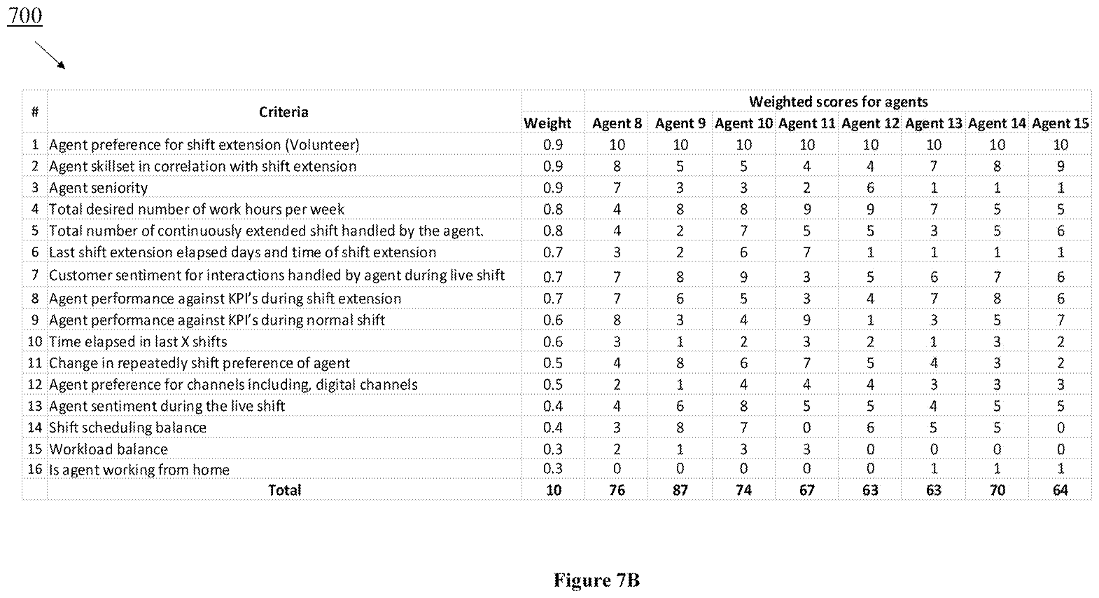

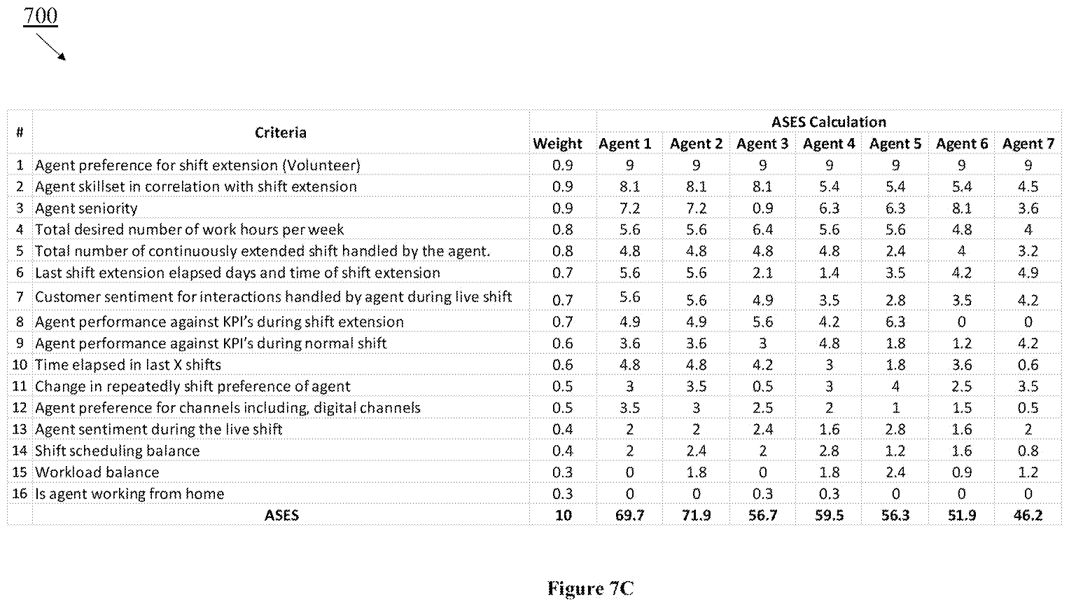

According to some embodiments of the present disclosure, the calculating of ASES for each agent in the agents having one or more skills which are assigned to the preassigned work-shift is according to formula I:

$$ASES Agent i = {\sum }_{Criterion k = 0}^{m} ( score of criterion k * Weight of criterion k ) \qquad ( I )$$

whereby:
m is the number of criteria, and the ASES score for Agent i is computed by summing up the products of the score of each criterion k and the preconfigured weight of that criterion k. The criteria may be one or more criteria as shown in FIGS. 7A-7C.

According to some embodiments of the present disclosure, retrieving from the shift-tracking data-store 170 one or more agents having a calculated ASES that is above a preconfigured ASES-threshold 140. For example, when the calculated number of extra-agents is two. i.e., two agents are required to handle additional calls by extending their currently ongoing work-shift.

According to some embodiments of the present disclosure, optionally, the calculating of ASES may be operated after a selection of agents from a list of agents marked as volunteered-for-extension and reducing the selected number of agents from the list of agents marked as volunteered-for-extension from the number of extra-agents.

According to some embodiments of the present disclosure, the agents which are retrieved from the shift-tracking data-store 170 may be agents having a ASES above a preconfigured ASES-threshold 140, e.g., 50. From the retrieved agents, having a ASES above 50, operating agent selection based on ASES 145, by prioritizing the top two agents for the work-shift extension and select required number of agents 160.

According to some embodiments of the present disclosure, the remaining selected agents from the retrieved one or more agents having a calculated ASES above the preconfigured ASES-threshold will be available as a backup if needed. For example, after the selecting of the number of extra-agents from the retrieved one or more agents having a calculated ASES, marking agents from the retrieved one or more agents that were not selected as backup.

According to some embodiments of the present disclosure, when the retrieved one or more agents having a calculated ASES that is above a preconfigured ASES-threshold is below the determined number of agents to handle inbound-interactions that require one or more skills, e.g., only one agent is retrieved when two are needed, then select required number of agents including next available agents by lowering ASES threshold 155, e.g., by updating the preconfigured ASES-threshold by a preconfigured percentage, and then retrieving agents having a ASES above the updated threshold from the shift-tracking data-store 170 again and selecting the required number of extra-agents that have the highest ASES.

According to some embodiments of the present disclosure, shift extended 165 for the extra-agents may be operated by updating the corresponding schedules of the selected number of extra-agents, in a database of a Workforce Management (WFM) system.

According to some embodiments of the present disclosure, the shift-extension module, such as agent shift extension module 320 in FIG. 3 may regularly assess the status of the successive work-shift while it is ongoing and may further rotate the agents that have extended their work-shift from the previous one in order to balance the workload and scheduling. The agents for the rotation may be selected from the agents having ASES above the threshold.

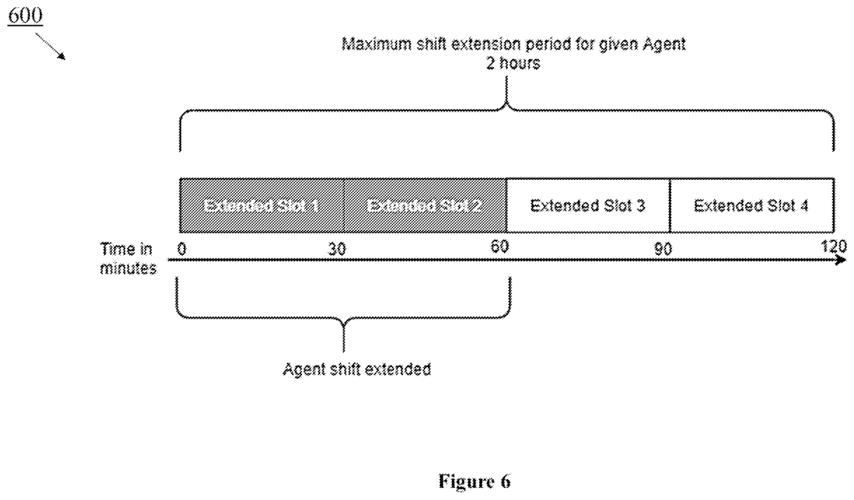

According to some embodiments of the present disclosure, commonly, a work-shift is configured to be extended to less than a whole shift which means than the successive work-shift where the extra-agents are required has to be divided into time slots. For example, agents cannot exceed the maximum allowed extended shift period, which can be set as a configurable time period such as 2 or 4 hours. Each extended shift may be divided into time slots, such as 30-minute slots within a 2-hour shift period, for example as shown in FIG. 6.

According to some embodiments of the present disclosure, optionally, during the successive work-shift, which has been divided into slots, after each slot, the agent shift extension module may review by operating a forecast module to check whether further extension is necessary. Once an agent completes an extended shift and additional agents are still required, the agent shift extension module may prioritize previously retrieved agents having the one or more skills which their ASES is above the threshold if they are available. If not, the agent shift extension module may reassess the available agents to meet the requirements.

According to some embodiments of the present disclosure, during the successive work-shift, operating the shift-extension module to check a duration of extension of time for each agent that has extended the previous work-shift, against maximum-allowable duration and rotating each agent that the duration of time has exceeded the maximum-allowable duration to balance the workload and scheduling.

According to some embodiments of the present disclosure, in contact centers, Voluntary Time Off (VTO) and Paid Time Off (PTO) are methods which are uses to reduce staff hours when there is an overstaffing situation. To manage overstaffing, it is possible to pinpoint employees who could be given PTO/VTO to cut back on their hours, taking into account their previous service performance during the timeframe of reduced hours.

According to some embodiments of the present disclosure, staff members with lower service quality ratings, e.g., lower ASES should be offered VTO/PTO first when the contact center is in a situation of overstaffing and needs to trim down the extra workforce, rather than those with higher ratings, e.g., higher ASES. The ASES is a combination of various different factors, such as performance, attendance, seniority etc. It may be used as an indicator and decisive factor for selecting agents to reduce overstaffing.

According to some embodiments of the present disclosure, when the determined number of agents to handle inbound-interactions that require one or more skills for the successive work-shift number is lower than the number of agents that were assigned to the successive work-shift calculating Agent Shift Extension Score (ASES) for each agent having one or more skills which are assigned to the preassigned ongoing work-shift and sending Voluntary Time Off (VTO) and Paid Time Off (PTO) suggestions to a computerized-device of an excess-number of agents having lowest calculated ASES.

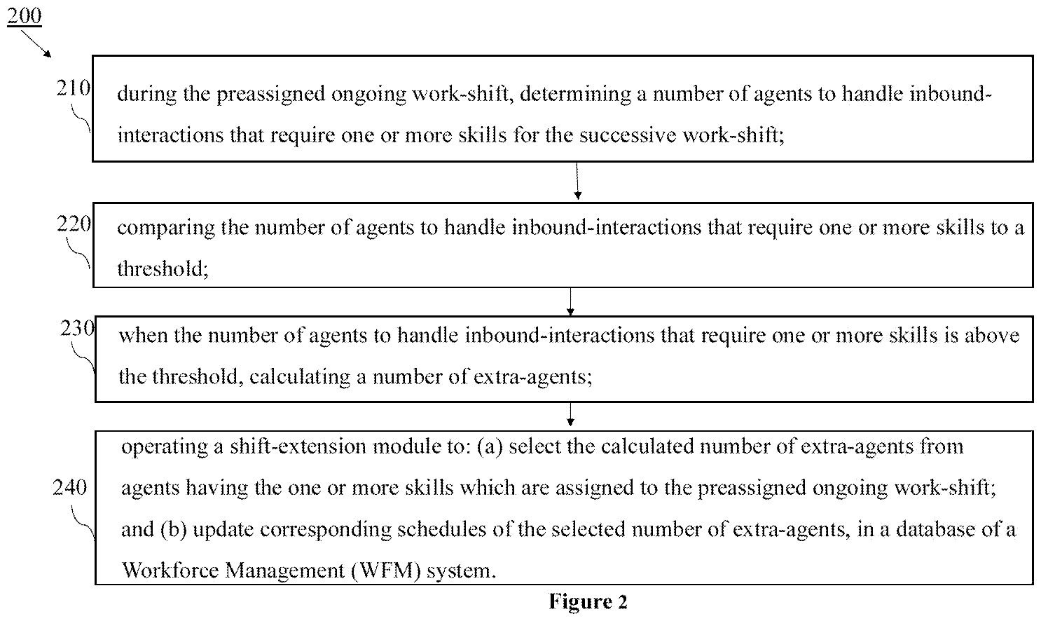

FIG. 2 is a high-level workflow of a computer-implemented method for adjusting agents staffing levels of a successive work-shift of a preassigned ongoing work-shift, during the preassigned ongoing work-shift, in a contact center, in accordance with some embodiments of the present disclosure.

According to some embodiments of the present disclosure, operation 210 comprising during the preassigned ongoing work-shift, determining a number of agents to handle inbound-interactions that require one or more skills for the successive work-shift.

According to some embodiments of the present disclosure, operation 220 comprising comparing the number of agents to handle inbound-interactions that require one or more skills to a threshold.

According to some embodiments of the present disclosure, operation 230 comprising when the number of agents to handle inbound-interactions that require one or more skills is above the threshold, calculating a number of extra-agents.

According to some embodiments of the present disclosure, operation 240 comprising operating a shift-extension module to: (a) select the calculated number of extra-agents from agents having the one or more skills which are assigned to the preassigned ongoing work-shift; and (b) update corresponding schedules of the selected number of extra-agents, in a database of a Workforce Management (WFM) system.

FIG. 3 schematically illustrates a high-level diagram of a system 300 for adjusting agents staffing levels of a successive work-shift of a preassigned ongoing work-shift, during the preassigned ongoing work-shift, in a contact center, in accordance with some embodiments of the present disclosure.

According to some embodiments of the present disclosure, in a system such as system 300 for adjusting agents staffing levels of a successive work-shift of a preassigned ongoing work-shift, during the preassigned ongoing work-shift, in a contact center, a computer-implemented method, such as computer-implemented method 200 for adjusting agents staffing levels of a successive work-shift of a preassigned ongoing work-shift, during the preassigned ongoing work-shift, in a contact center, may be implemented.

According to some embodiments of the present disclosure, system 300 may manage situations of understaffing and overstaffing in a contact center, by utilizing existing agents of a preassigned ongoing work-shift to handle temporary call surges, that is forecasted in a successive work-shift. Thus, the system 300 may prevent the need for overstaffing.

According to some embodiments of the present disclosure, staffing needs may be forecasted to prevent both understaffing and overstaffing scenarios. A module, such as agent shift extension module 320 may be operated during a preassigned ongoing work-shift, to adjust agents staffing levels of a preassigned successive work-shift of a preassigned ongoing work-shift, during the preassigned ongoing work-shift, in a contact center.

According to some embodiments of the present disclosure, the agent shift extension module 320 may check if there is a need for shift extension of agents which are currently assigned to the ongoing work-shift based on forecasting data 310b of the successive work-shift. The forecasting data of the successive work-shift may be received by a forecasting module. For example, determining a number of agents to handle inbound-interactions that require one or more skills for the successive work-shift. The determining of the number of agents to handle inbound-interactions that require one or more skills may be operated by a forecasting module.

According to some embodiments of the present disclosure, the determined number of agents to handle inbound-interactions that require one or more skills for the successive work-shift 340 may be compared to a threshold. The threshold may be a sum of a number of agents having the one or more skills which are assigned to the successive work-shift and a preconfigured buffer.

According to some embodiments of the present disclosure, when the number of agents to handle inbound-interactions that require one or more skills may be above the threshold, a number of extra-agents may be calculated. Then, a shift-extension module may be operated to select the number of extra-agents from agents having the one or more skills which are assigned to the preassigned ongoing work-shift 340 and to update corresponding schedules of the selected number of extra-agents in a database of a WFM system 330c. The number of extra-agents from agents having the one or more skills which are assigned to the preassigned ongoing work-shift 340 may be retrieved from the WFM system 330c which may also include other available agents 350.

According to some embodiments of the present disclosure, when the determined number of agents to handle inbound-interactions that require one or more skills for the successive work-shift 340 may be higher than the number of agents that were assigned to the successive work-shift and below the threshold, a notification may be sent as to an overstaffing scenario to a computerized device to be displayed thereon.

According to some embodiments of the present disclosure, the agent shift extension module 320 may be based on incoming data sources 310a-310e which includes agent information 310a such as Agent Id, Agent Skillset, Seniority, Agent's preference, volunteer for extension or not, forecasting data 310b, agent performance metrics 310c, available agent information 310d, e.g., agents which are assigned to the ongoing work-shift, and interaction content analysis 310e e.g., customer sentiment for interactions handled by agent during live shift, agent's sentiment during the live shift.

According to some embodiments of the present disclosure, the agent shift extension module 320 may include: (i) calculating Agent Shift Extension Score (ASES) for each agent having one or more skills which are assigned to the preassigned ongoing work-shift; (ii) sorting the agents having one or more skills which are assigned to the preassigned work-shift based on the calculated ASES in a descending order and storing the agents having one or more skills which are assigned to the preassigned work-shift and calculated ASES in a data-store, such as shift-tracking data-store 360.

According to some embodiments of the present disclosure, the agent shift extension module 320 may further include: (iii) retrieving from the shift-tracking data-store one or more agents having a calculated ASES that is above a preconfigured ASES-threshold; (iv) when the retrieved one or more agents having a calculated ASES that is above a preconfigured ASES-threshold is not below the determined number of agents to handle inbound-interactions that require one or more skills, selecting the number of extra-agents from the retrieved one or more agents having a calculated ASES; and (v) when the retrieved one or more agents having a calculated ASES that is above a preconfigured ASES-threshold is below the determined number of agents to handle inbound-interactions that require one or more skills, updating the preconfigured ASES-threshold by a preconfigured percentage and repeating operations (iii) thru (v) with the updated preconfigured ASES-threshold as the preconfigured ASES-threshold.

According to some embodiments of the present disclosure, when the determined number of agents to handle inbound-interactions that require one or more skills for the successive work-shift number is lower than the number of agents that were assigned to the successive work-shift calculating Agent Shift Extension Score (ASES) for each agent having one or more skills which are assigned to the preassigned ongoing work-shift and sending Voluntary Time Off (VTO) and Paid Time Off (PTO) suggestions to a computerized-device of an excess-number of agents having lowest calculated ASES.

According to some embodiments of the present disclosure, the calculating of ASES for each agent in the agents having one or more skills which are assigned to the preassigned work-shift is according to formula I:

$$ASES Agent i = {\sum }_{Criterion k = 0}^{m} ( score of criterion k * Weight of criterion k ) \qquad ( I )$$

whereby:
m is the number of criteria, and the ASES score for Agent i is computed by summing up the products of the score of each criterion k and the preconfigured weight of that criterion k.

According to some embodiments of the present disclosure, the selecting of the number of extra-agents from the retrieved one or more agents having a calculated ASES may include selecting the number of extra-agents from the retrieved one or more agents having highest calculated ASES.

According to some embodiments of the present disclosure, after the selecting of the number of extra-agents from the retrieved one or more agents having a calculated ASES marking agents from the retrieved one or more agents that were not selected, e.g., other available agents 350, as backup.

According to some embodiments of the present disclosure, the calculating of ASES may be operated after a selection of agents from a list of agents marked as volunteered-for-extension and reducing the selected number of agents from the list of agents marked as volunteered-for-extension from the number of extra-agents.

According to some embodiments of the present disclosure, the operating of the shift-extension module 320 may further include checking a duration of extension of time for each agent against maximum-allowable duration and may rotate each agent that the duration of time has exceeded the maximum allowable duration to balance the workload and scheduling with other agents having a ASES higher than the threshold.

According to some embodiments of the present disclosure, a reporting, such as reporting 330a may be operated after the update of corresponding schedules of the selected number of extra-agents, in a database of a Workforce Management (WFM) system 330c. The report may include details of the selected number of extra-agents, for example, agentId, agentName, agentShiftExtensionDetails for future reference.

According to some embodiments of the present disclosure, a gamification 330b may provide rewards and recognitions to agents who extended their scheduled work-shift for their proactiveness and commitment.

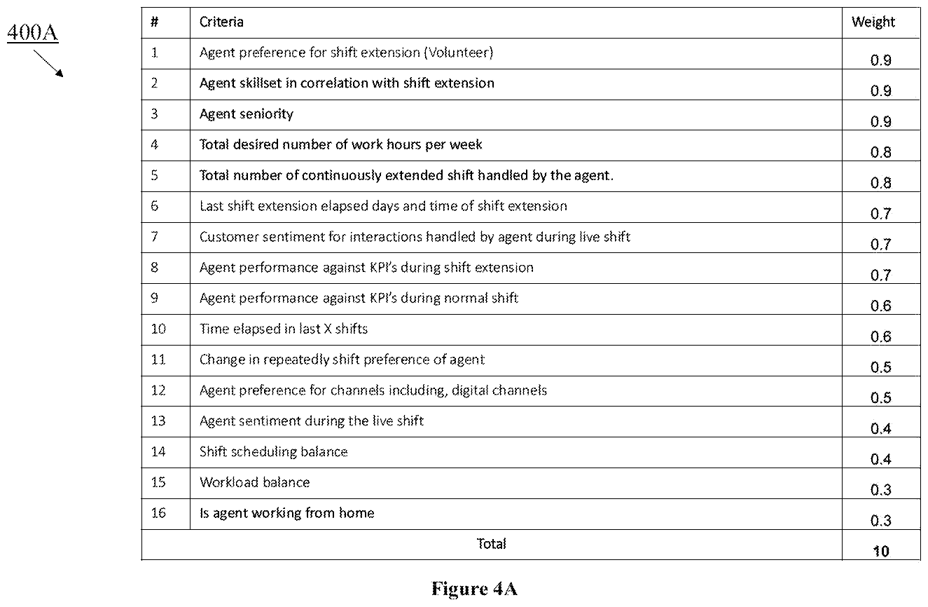

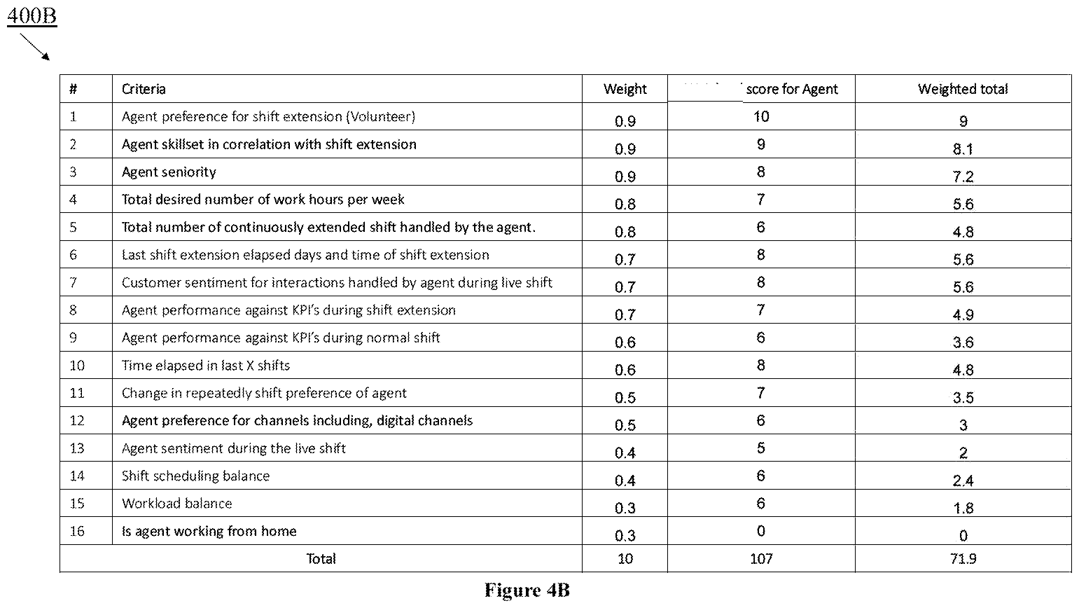

FIG. 4A is a table 400A of assigned weights to each criterion, in accordance with some embodiments of the present disclosure.

According to some embodiments of the present disclosure, the ASES may be calculated by operating formula I:

$$ASES Agent i = {\sum }_{Criterion k = 0}^{m} ( score of criterion k * Weight of criterion k ) \qquad ( I )$$

m is the number of criteria, and the ASES score for Agent i is computed by summing up the products of the score of each criterion k and the preconfigured weight of that criterion k.

According to some embodiments of the present disclosure, for example, the m criteria may be criteria shown in table 400 and the score may be the weight that is assigned to each criterion. The criteria may be for example, agent preference for shift extension, e.g., volunteer, agent skillset in correlation to shift extension, agent seniority, total number of desired number of work hours per week, total number of continuously extended shift handled by agent, last shift extension elapsed days, customer sentiment for interactions handled by agent during live shift, agent performance against KPI's during shift extension, agent performance against KPIs during normal shift, time elapsed in last X shifts, change in repeatedly shift preference of agent, agent preference for channel including digital channels, agent sentiment during live shift, shift scheduling balance, workload balance, is agent working from home.

FIG. 4B is a table 400B of weights assigned to key parameters, in accordance with some embodiments of the present disclosure.

According to some embodiments of the present disclosure, table 400B shows a weighted score for agent for each criterion to arrive at the agent ASES. The ASES may be the sum of the score of the criterion multiplied by the assigned weight of all criteria.

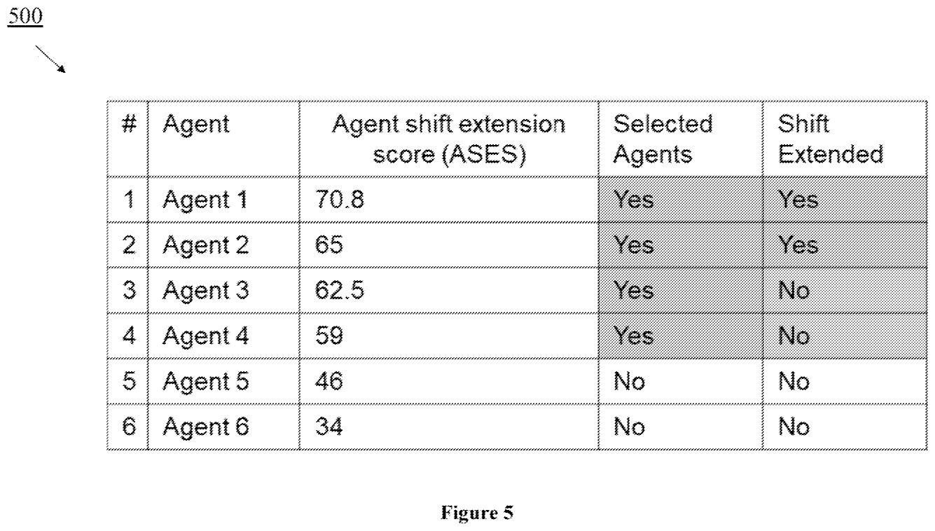

FIG. 5 is a table 500 of agent work-shift extension prioritization, in accordance with some embodiments of the present disclosure.

According to some embodiments of the present disclosure, for example, when the required extra-agents which are the agents needed after the shifts ends is two, and the selected agents from the preassigned ongoing work-shift having ASES above the ASES threshold, e.g., ‘50’ is 4, then, agent 1 and agent 2 have the highest ASES may be selected for the work-shift extension from the four agents having ASES above ‘50’, e.g., agent 1, agent 2, agent 3 and agent 4.

FIG. 6 is an example 600 of work-shift extension, in accordance with some embodiments of the present disclosure.

According to some embodiments of the present disclosure, in a system, such as system 300 in FIG. 3, a module, such as agent shift extension module 320 in FIG. 3 may assess the staff level required for an ongoing work-shift and may rotate agents that have extended their work-shift from previous work-shift to balance the workload and scheduling.

According to some embodiments of the present disclosure, when agents cannot exceed the maximum allowed extended shift period, which can be set as a configurable time period such as 2 or 4 hours. Each extended shift will also be divided into time slots, such as 30-minute slots within a 2-hour shift period. After each time slot, a module, such as agent shift extension module 320 in FIG. 3, may review whether the work-shift is still understaffed, and further extension is necessary. Once an agent completes an extended shift and additional agents are still required, i.e., the work-shift is still understaffed, the module may prioritize previously selected agents, for example, agent 3 and agent 4 in FIG. 5, if they are available. If not, the module may reassess the available agents to meet the requirements.

FIGS. 7A-7C is an example 700 of calculation of weighted scores for agents, in accordance with some embodiments of the present disclosure.

According to some embodiments of the present disclosure, in a system, such as system 300 in FIG. 3, when there is a sudden surge in call volume that is expected to continue in a successive work-shift, then when there is a group of agents who have volunteered to work in the extended work-shift, the most suitable agents may be selected. When there are not enough agents from the agents that volunteered for extended work-shift, a real-time notification may be sent to agents having the highest ASES asking them if they are willing to extend their work-shift.

According to some embodiments of the present disclosure, for example, when the total number of available agents is 35 and 15 agents have volunteered for work-shift extension, then when the forecast is that there are 6 agents required in addition to the agents scheduled for the successive work-shift, and the agent threshold is set to 5 then
If Shift extension needed=(Agent Required Count>Threshold)→6>5=True
Then, Get all the agents volunteered for shift extension.

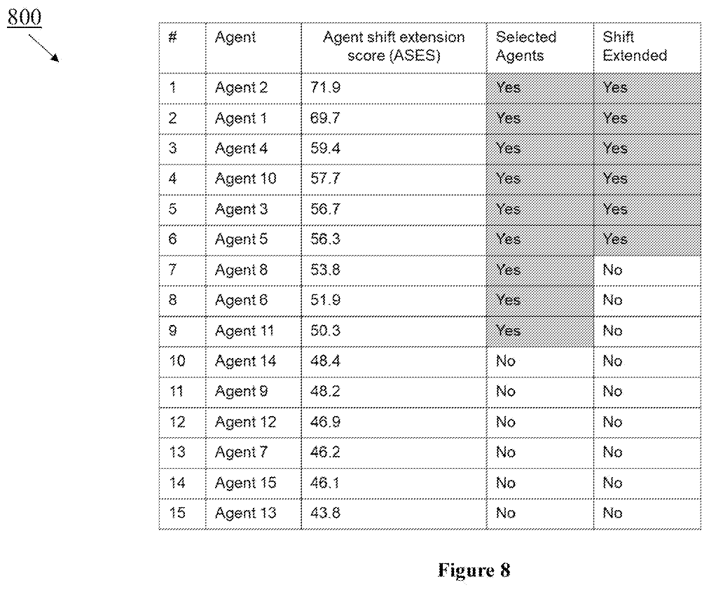

FIG. 8 is an example 800 of agents selection for further work-shift extension, in accordance with some embodiments of the present disclosure.

According to some embodiments of the present disclosure, based on the ASES scores of the agents in FIGS. 7A-7C, when there are 6 agents needed for the successive work-shift, then out of 35 available agents, a total of 15 agents volunteered for work-shift extension 9 agents have been selected which their ASES is above a threshold, e.g., 50. Out of the 9 agents the 6 agents having the highest ASES may be selected.

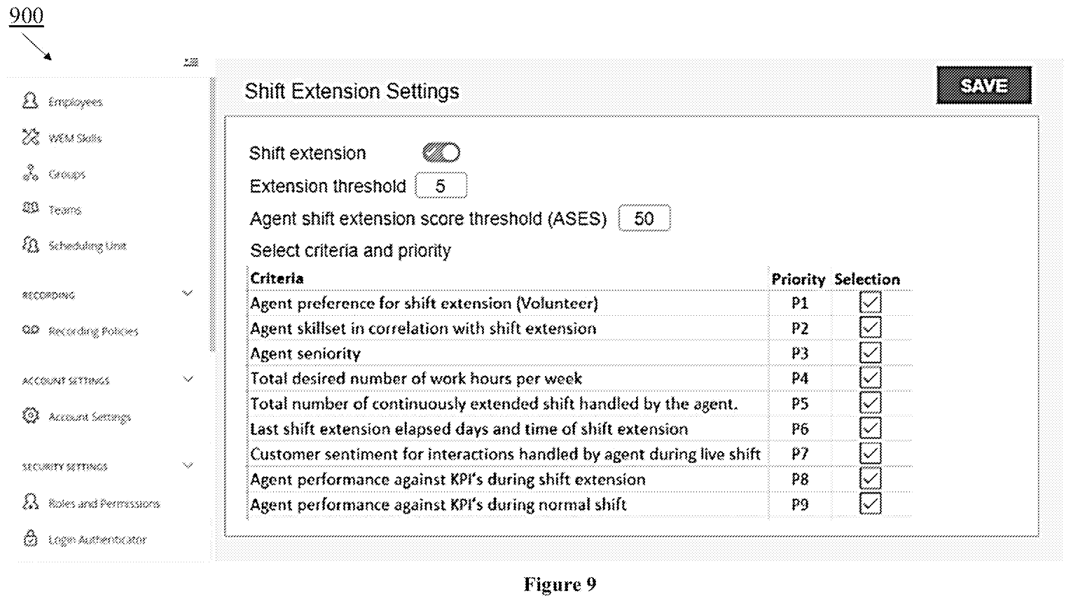

FIG. 9 is an example of User Interface (UI) 900 for work-shift extension, in accordance with some embodiments of the present disclosure.

According to some embodiments of the present disclosure, a system, such as system 300 in FIG. 3, may include a UI, such as UI 900 to enable a user to enter extension threshold, e.g., threshold of the least number of agents needed to trigger the consideration of extending work-shifts. A threshold to the required ASES and related criteria for the ASES calculation.

According to some embodiments of the present disclosure, the criteria may be associated a priority, e.g., ‘P1’-‘P9’, which is the desired arrangement of shift extension criteria. For example, criterion with priority ‘P1’ may be assigned the highest weight compared to criterion with priority ‘P9’, as shown in table 400A in FIG. 4A.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computer-implemented method for adjusting agents staffing levels of a successive work-shift of a preassigned ongoing work-shift, during the preassigned ongoing work-shift, in a contact center, said computer-implemented method comprising:
(i) during the preassigned ongoing work-shift, determining a number of agents to handle inbound-interactions that require one or more skills for the successive work-shift;
(ii) comparing the number of agents to handle inbound-interactions that require one or more skills to a threshold;
(iii) when the number of agents to handle inbound-interactions that require one or more skills is above the threshold, calculating a number of extra-agents; and
(iv) operating a shift-extension module to: (i) select the number of extra-agents from agents having the one or more skills which are assigned to the preassigned ongoing work-shift; and (ii) update corresponding schedules of the selected number of extra-agents, in a database of a Workforce Management (WFM) system.

2. The computer-implemented method of claim 1, wherein the determining of the number of agents to handle inbound-interactions that require one or more skills is operated by a forecasting module.

3. The computer-implemented method of claim 1, wherein the threshold is a sum of a number of agents having the one or more skills which are assigned to the successive work-shift and a preconfigured buffer.

4. The computer-implemented method of claim 1, wherein the calculating of the number of extra-agents comprising reducing from the number of agents to handle inbound-interactions that require one or more skills a number of agents that are currently assigned to the successive work-shift.

5. The computer-implemented method of claim 1, wherein the shift-extension module comprising:
(i) calculating Agent Shift Extension Score (ASES) for each agent having one or more skills which are assigned to the preassigned ongoing work-shift;
(i) sorting the agents having one or more skills which are assigned to the preassigned work-shift based on the calculated ASES in a descending order and storing the agents having one or more skills which are assigned to the preassigned work-shift and calculated ASES in a shift-tracking data-store;
(iii) retrieving from the shift-tracking data-store one or more agents having a calculated ASES that is above a preconfigured ASES-threshold;
(iv) when the retrieved one or more agents having a calculated ASES that is above a preconfigured ASES-threshold is not below the determined number of agents to handle inbound-interactions that require one or more skills, selecting the number of extra-agents from the retrieved one or more agents having highest ASES; and
(v) when the retrieved one or more agents having a calculated ASES that is above a preconfigured ASES-threshold is below the determined number of agents to handle inbound-interactions that require one or more skills, updating the preconfigured ASES-threshold by a preconfigured percentage and repeating operations (iii) thru (v) with the updated preconfigured ASES-threshold as the preconfigured ASES-threshold.

6. The computer-implemented method of claim 5, wherein the calculating of ASES for each agent in the agents having one or more skills which are assigned to the preassigned work-shift is according to formula I:
$$ASES Agent i = {\sum }_{Criterion k = 0}^{m} ( score of criterion k * Weight of criterion k ) \qquad ( I )$$
whereby:
m is the number of criteria, and the ASES score for Agent i is computed by summing up the products of the score of each criterion k and the preconfigured weight of that criterion k.

7. The computer-implemented method of claim 5, wherein the selecting of the number of extra-agents from the retrieved one or more agents having a calculated ASES comprising selecting the number of extra-agents from the retrieved one or more agents having highest calculated ASES.

8. The computer-implemented method of claim 5, wherein after the selecting of the number of extra-agents from the retrieved one or more agents having a calculated ASES marking agents from the retrieved one or more agents that were not selected as backup.

9. The computer-implemented method of claim 5, wherein the calculating of ASES is operated after a selection of agents from a list of agents marked as volunteered-for-extension and reducing the selected number of agents from the list of agents marked as volunteered-for-extension from the number of extra-agents.

10. The computer-implemented method of claim 1, wherein the operating of the shift-extension module further comprising: checking a duration of extension of time for each agent against maximum-allowable duration and rotating each agent that the duration of time has exceeded the maximum-allowable duration to balance the workload and scheduling.

11. The computer-implemented method of claim 1, wherein when the determined number of agents to handle inbound-interactions that require one or more skills for the successive work-shift number is higher than the number of agents that were assigned to the successive work-shift and below the threshold, the computer-implemented method further comprising sending a notification as to an overstaffing scenario to a computerized device to be displayed thereon.

12. The computer-implemented method of claim 1, wherein when the determined number of agents to handle inbound-interactions that require one or more skills for the successive work-shift number is lower than the number of agents that were assigned to the successive work-shift calculating Agent Shift Extension Score (ASES) for each agent having one or more skills which are assigned to the preassigned ongoing work-shift and sending Voluntary Time Off (VTO) and Paid Time Off (PTO) suggestions to a computerized-device of an excess-number of agents having lowest calculated ASES.
